(19) United States
(12) Patent Application Publication
(10) Pub. No.: US 2006/0250462 A1
(43) Pub. Date: Nov. 9, 2006

(54) Printer and ink cartridge carrier thereof

(76) Inventor: Chin-Shu Yu, Banciao City (TW)

Correspondence Address: RABIN & Berdo, PC, 1101 14TH STREET, NW, SUITE 500, WASHINGTON, DC, 20005, US

(21) Appl. No.: 11/416,103

(22) Filed: May 3, 2006

(30) Foreign Application Priority Data
May 5, 2005 (TW) 94114556

(51) Int. Cl. B41J 2/175

(52) U.S. Cl. 347/87

(57) ABSTRACT

A printer and an ink cartridge carrier thereof are provided. The ink cartridge carrier comprises a carrier body and a cover. The carrier body has a containing chamber for receiving N ink cartridges, and the N is a positive integer. The cover is pivoted to the carrier body. The cover comprises a cover body and N pendent portions. The N pendent portions and the cover body are formed in an integral structure. The N pendent portions press the N ink cartridges, so that the N ink cartridges are fastened within the containing chamber.

This application claims the benefit of Taiwan application Serial No. 94114556, filed May 5, 2005, the subject matter of which is incorporated herein by reference.

### BACKGROND OF THE INVENTION

1. Field of the Invention

The invention relates in generally to a printer and an ink cartridge carrier thereof, and more particularly to a printer and an ink cartridge carrier with a cover having a pendent portion and a suspending arm.

2. Description of the Related Art

A multi-function peripheral (MFP) is a current office apparatus, which provides the functions of copying, printing, faxing, and scanning, etc. The MFP have the advantages of making office affairs more convenient and smoothly, and integrating multi-functions, and saving occupying space. As the above reasons, the MFP becomes a popular and necessary machine for office affairs. Traditionally, the MFP at least includes a scanning module and a printing module. The printing module at least includes a printing platform and an ink cartridge carrier. The ink cartridge carrier is disposed movably on the printing platform. At least one ink cartridge is disposed within the ink cartridge carrier, and the ink cartridge is used for performing a printing operation on a paper. The scanning module is often disposed above the printing module. For consideration of keeping enough space for user changing the ink cartridge carrier, the scanning module must keep a predetermined distance away from the ink cartridge carrier, wherein the predetermined distance is decided depending on the fastening method of the ink cartridge carrier. A conventional ink cartridge carrier and a conventional fastening method of the ink cartridge carrier are described in the following detailed description and accompanying drawings.

Reference is made to FIGS. 1A-1C. FIG. 1A depicts a perspective and exploding view showing a prior ink cartridge carrier. FIG. 1B depicts a perspective view showing a prior ink cartridge and the ink cartridge carrier of FIG. 1A after assembling. FIG. 1C depicts a perspective view showing the ink cartridge disposed within the assembled ink cartridge carrier of FIG. 1B. As shown in FIGS. 1A-1C, the ink cartridge carrier 100 comprises a body 101, covers 106 and 108. The body 101 is separated into a supporting component 102 and a frame 104. The supporting component 102 includes a supporting chassis 102a and a back retaining plate 102b. The frame 104 includes a front retaining plate 104a opposite to the back retaining plate 102b, a connecting plate 104b, and side retaining plates 104c and 104d which corresponds to each other. Both the front retaining plate 104a and the connecting plate 104b connect with side retaining plates 104c and 104d. The connecting plate 104b includes positioning holes (126, 128). While the supporting component 102 combines with the frame 104 to form the body 101, the back retaining plate 102b is disposed under the connecting plate 104b, as shown in FIG. 1B. At the same time, the supporting chassis 102a, the back retaining plate 102b, the front retaining plate 104a and the side retaining plates 104c and 104d surround together to form a containing chamber 104e, which is used for receiving ink cartridges 122 and 124.

One side of each covers 106 and 108 connects pivotally with the front retaining plate 104a, as shown in FIG. 1B, so that the covers 106 and 108 could swing forward and backward along an arrow 60 beyond the front retaining plate 104a. Furthermore, another side of each covers 106 and 108 includes hooks 130 and 132, which are used for hooking the positioning holes 126 and 128. The cover 106 includes springs 110 and 112 and spring protection covers 116 and 118. The cover 108 includes a spring 114 and a spring protection cover 120. The spring protection covers 116 and 118 move on the bottom surface of the cover 106 covering the springs 110 and 112, as shown in FIG. 1B. In addition, both ends of the spring 110 are against the bottom surface of the cover 106 and the inner surface of the spring protection cover 116. And both ends of the spring 112 are against the bottom surface of the cover 106 and the inner surface of the spring protection cover 118. The spring protection cover 120 can move on the bottom surface of the cover 108 covering the spring 114, as shown in FIG. 1B, and both ends of the spring 114 are also against the bottom surface of the cover 108 and the inner surface of the spring protection cover 120.

When the ink cartridges 122 and 124 are disposed within the containing chamber 104e, the covers 106 and 108 could swing forward and backward along the arrow 60, as shown in FIG. 1B. The hooks 130 and 132 are lodged in the positioning holes 126 and 128, as shown in FIG. 1C. At the same time, the covers 106 and 108 could seal almost the whole opening of the containing chamber 104e. The springs 110 and 112 press the ink cartridge 122 into the containing chamber 104e via the spring protection covers 116 and 118. And the spring 114 presses the ink cartridge 124 into the containing chamber 104e via the spring protection cover 120. Therefore, a user could change the ink cartridges 122 and 124 of the ink cartridge carrier 100 by the covers 106 and 108 flipped above the front retaining plate 104a.

However, the above-mentioned prior method that the cover of the ink cartridge carrier flipped for changing the ink cartridges needs very large space, so that the scanning module disposed over the ink cartridge carrier must be accordingly separated from the ink cartridge carrier in a very large predetermined distance for matching the requirements of industrial safety. As a result, a prior multi-function peripheral (MFP) always occupies a large volume, which could not match the current design requirements of small and light electronic devices. Furthermore, some multi-function peripheral (MFP) includes a scanning module which is also designed to be a flipper structure. However, it is very inconvenient that the user needs to flip the scanning module before flipping the cover of the ink cartridge carrier for changing the ink cartridges. In addition, the prior multi-function peripheral (MFP) comprises lots of components, such as springs and spring protection covers, which generates the shortcomings of cost much, man power wasting and complexity for assembling.

### SUMMARY OF THE INVENTION

It is an aspect of the present invention to provide a printer and an ink cartridge carrier thereof. The ink cartridge carrier has a cover with a pendent portion and a suspending arm, which could be flipped over a back retaining plate, so that the operation space of the cover is saved, and the printer could be smaller and lighter than prior art.

According to the aforementioned aspect of the present invention, an ink cartridge carrier is provided. The ink cartridge carrier comprises a carrier body and a cover. The carrier body has a containing chamber for receiving N ink cartridges, and the N is a positive integer. The cover connects pivotally with the carrier body in a swinging way. That is, the cover could swing forward and backward on the carrier body. The cover comprises a cover body and N pendent portions. The N pendent portions and the cover body are formed in an integral structure. The N pendent portions press the N ink cartridges, so that the N ink cartridges are fastened within the containing chamber.

The carrier body includes a first side retaining plate having a first positioning hole, and the cover further comprises a first linking shaft, a first forcing arm, and a first hook. The first linking shaft has a first end and a second end, the first end connects with the cover body, and the second end is elongated from the cover body to the top of the containing chamber. The first forcing arm connects with the second end, and the first hook connects perpendicular to the first linking shaft and between the first end and the second end. The first hook, the first forcing arm and the first linking shaft are together to form a first “T” shaped structure. When the first hook is lodged in the first positioning hole, the N pendent portions press the N ink cartridges tightly, and when the first forcing arm is forced, the first hook releases from the first positioning hole.

The carrier body further includes a second side retaining plate opposite to the first side retaining plate, which has a second positioning hole. The cover further comprises a second linking shaft, a second forcing arm and a second hook. The second linking shaft has a third end and a fourth end, the third end connects with the cover body, and the fourth end is elongated from the cover body to the top of the containing chamber. The second forcing arm connects with the fourth end. The second hook connects perpendicular to the second linking shaft and between the third end and the fourth end. The second hook, the second forcing arm and the second linking shaft are together to form a second “T” shaped structure. When the second hook is lodged in the second positioning hole, the N pendent portions press the N ink cartridges tightly, and when the first forcing arm and the second forcing arm are forced to close to each other, the first hook and the second hook release from the first positioning hole and the second positioning hole respectively. Each of the N pendent portions is an elastic body.

According to the aforementioned aspect of the present invention, a printer is provided. The printer includes an ink cartridge carrier, which comprises a carrier body and a cover. The carrier body has a containing chamber for receiving N ink cartridges, and the N is a positive integer. The cover connects pivotally with the carrier body in a swinging way. That is, the cover could swing forward and backward on the carrier body. The cover comprises a cover body and N pendent portions. The N pendent portions and the cover body are formed in an integral structure. The N pendent portions press the N ink cartridges, so that the N ink cartridges are fastened within the containing chamber. Each of the N pendent portions is an elastic body.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A (Prior Art) depicts a perspective and exploding view showing a prior ink cartridge carrier;

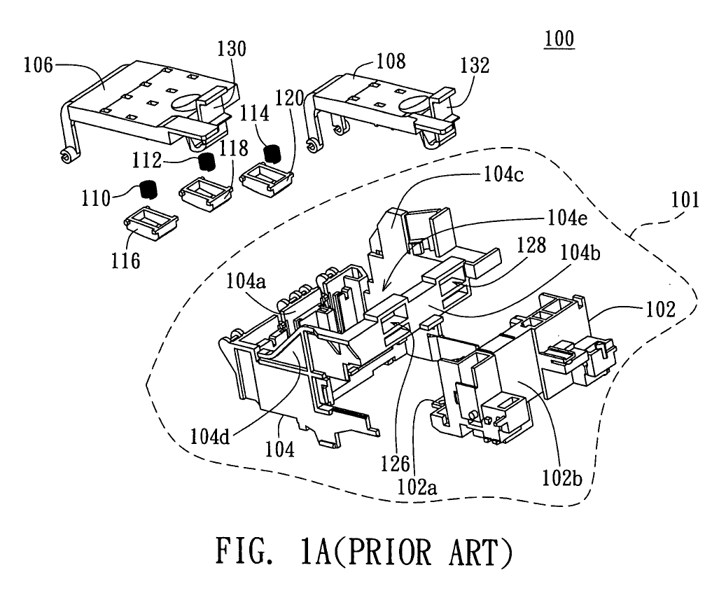

FIG. 1B (Prior Art) depicts a perspective view showing a prior ink cartridge and an ink cartridge carrier after assembling in accordance with FIG. 1A;

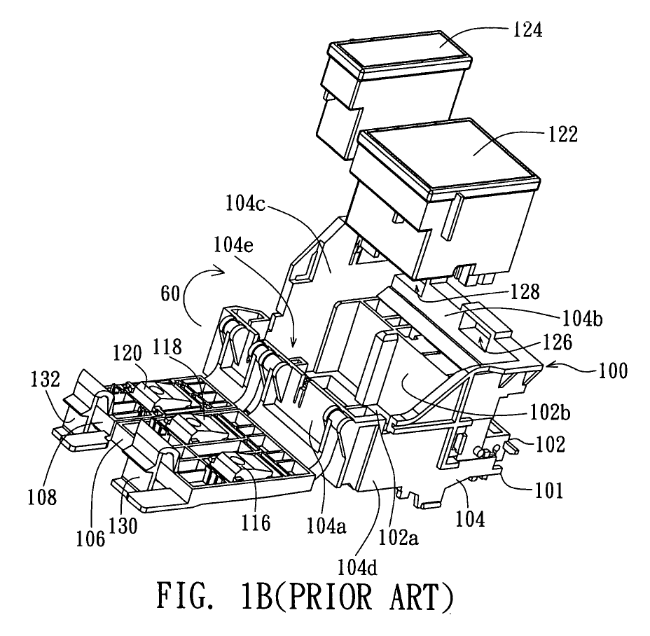

FIG. 1C (Prior Art) depicts a perspective view showing the ink cartridge disposed within the ink cartridge carrier in accordance with FIG. 1B;

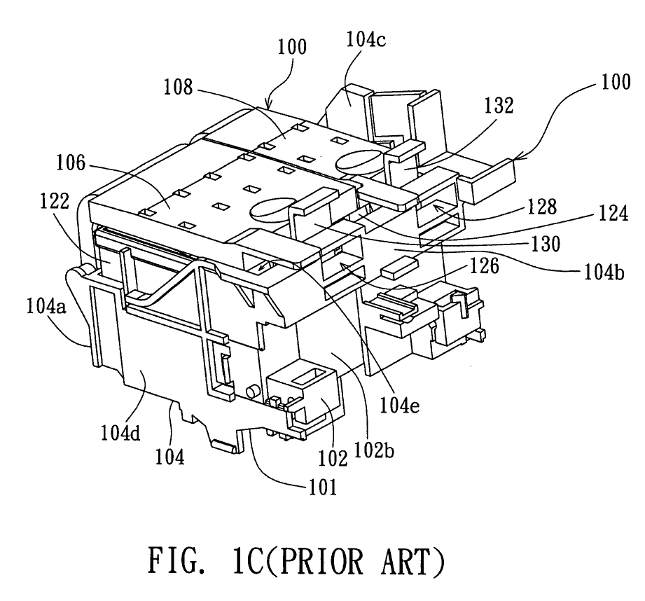

FIG. 2 depicts an exploding view showing an ink cartridge carrier in accordance with the preferred embodiment of the present invention;

FIG. 3 depicts a perspective view showing the ink cartridge carrier after assembling in accordance with FIG. 2;

FIG. 4 depicts a perspective view showing the backside of the securing member and the positioning box at a beginning position in accordance with the first preferred embodiment of the present invention;

FIG. 5 depicts a perspective view showing the backside of the securing member and the positioning box at a locking position in accordance with the first preferred embodiment of the present invention; and

FIG. 6 depicts a perspective view showing a securing member in accordance with the second preferred embodiment of the present invention;

### DETAILED DESCRIPTION OF THE INVENTION

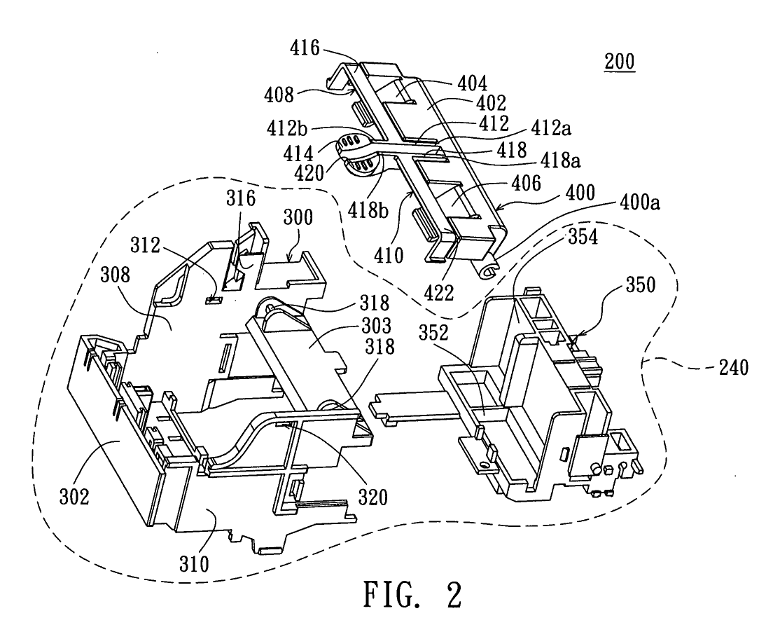

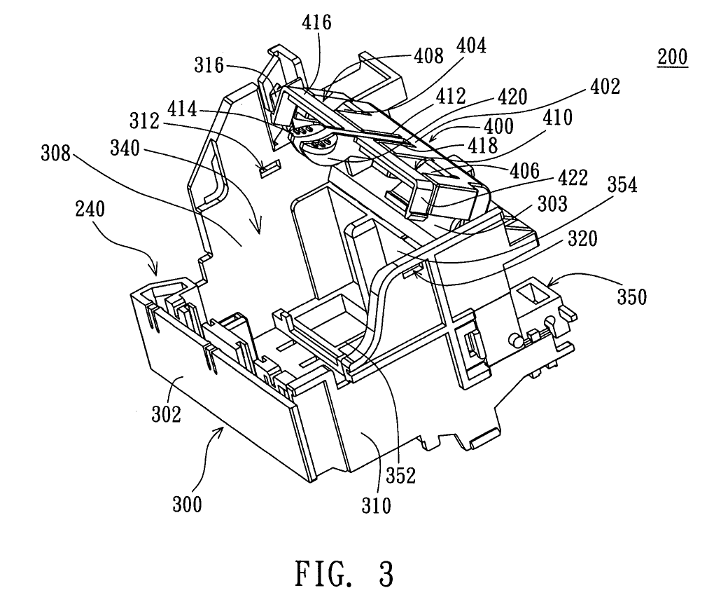

Reference is made to FIGS. 2-3. FIG. 2 depicts an exploding view showing an ink cartridge carrier in accordance with the preferred embodiment of the present invention. FIG. 3 depicts a perspective view showing the ink cartridge carrier after assembling in accordance with FIG. 2. As shown in both FIGS. 2-3, an ink cartridge carrier 200 is disposed in a printer (not shown). The ink cartridge carrier 200 comprises a carrier body 240 and a cover 400. The carrier body 240 includes a containing chamber 340, as shown in FIG. 3. The containing chamber 340 is used for receiving N ink cartridges. The N is a positive integer. The cover 400 connects pivotally with the carrier body 240 in a swinging way. That is, the cover 400 could swing forward and backward on the carrier body 240. The cover 400 includes a cover body 402 and N pendent portions, such as two pendent portions 404 and 406, for example. The N pendent portions and the cover body 402 are formed in an integral structure. The N pendent portions press the N ink cartridges, so that the N ink cartridges could be fastened within the containing chamber 340.

As described in the preferred embodiment of the present invention, the carrier body 240 includes a supporting component 350 and a frame 300. The supporting component 350 includes a supporting chassis 352 and a back retaining plate 354. The frame 300 includes a front retaining plate 302, a back connecting plate 303, a first side retaining plate 308 and a second side retaining plate 310. The front retaining plate 302 is opposite to the back retaining plate 354, and the first side retaining plate 308 and the second side retaining plate 310 are opposite to each other. Both the front retaining plate 302 and the back connecting plate 303 connect with the first side retaining plate 308 and the second side retaining plate 310. The inner surfaces of the first side retaining plate 308 and the second side retaining plate 310 includes a first positioning hole 312 and a second positioning hole 320, respectively. When the supporting component 350 is combined with the frame 300 to form the carrier body 240, the back retaining plate 354 is positioned under the back connecting plate 303, as shown in FIG. 3. At this time, the front retaining plate 302, the back retaining plate 354, the supporting chassis 352, the first side retaining plate 308 and the second side retaining plate 310 surround together to form the containing chamber 340. The carrier body 240 could be an integral structure, instead of being separated into the supporting component 350 and the frame 300.

The cover 400 connects pivotally with the carrier body 240, and the cover 400 moves above the back retaining plate 354, as shown in FIG. 3. The cover 400 swings between a fixing position and a flipping position. As described in the preferred embodiment of the present invention, the cover 400 includes a cover body 402, a first pendent portion 404, a second pendent portion 406, a first suspending arm 408 and a second suspending arm 410. The first pendent portion 404 and the second pendent portion 406 are disposed on the bottom surface of the cover body 402. The first pendent portion 404 and the second pendent portion 406 are for pressing the ink cartridges when the cover 400 is on the fixing position, which will be described following in detail. The first pendent portion 404 the second pendent portion 406 and the cover body 402 are preferred formed in an integral structure.

The first suspending arm 408 includes a first linking shaft 412, a first forcing arm 414 and a first hook 416. The second suspending arm 410 includes a second linking shaft 418, a second forcing arm 420 and a second hook 422. The first linking shaft 412 has a first end 412a and a second end 412b, and the second linking shaft 418 has a third end 418a and a fourth end 418b. The first end 412a and the third end 418a are separated and connect with one side of the cover body 402. The second end 412b and the fourth end 418b are parallel elongated from the cover body 402 to the top of the containing chamber 340, as shown in FIG. 3. The first forcing arm 414 connects with the second end 412b, and the second forcing arm 420 connects with the fourth end 418b. The first hook 416 and the second hook 422 connects and perpendicular to the first linking shaft 412 and the second linking shaft 418, respectively. The first hook 416 and the second hook 422 are elongated from the first linking shaft 412 and the second linking shaft 418 in reverse directions, respectively. The first hook 416 connects with the first linking shaft 412 at a position between the first end 412a and the second end 412b, and the second hook 422 connects with the second linking shaft 418 at a position between the third end 418a and the fourth end 418b. The first hook 416 and the second hook 422 are disposed between the cover body 402, the first forcing arm 414 and the second forcing arm 420. The first hook 416 and the second hook 422 are used for hooking the first positioning hole 312 and the second positioning hole 320, respectively. Furthermore, the first suspending arm 408 and the second suspending arm 410 are combined with the cover body 402 to form two integral “T” shaped structures.

As described in the preferred embodiment of the present invention, the ink cartridge carrier 200 further comprises a pivot, which is used for connecting the cover 400 and the carrier body 240. For example, the pivot includes a C-shaped hook 400a and a bolt 318, as shown in FIG. 2, which work together to connect the cover 400 and the carrier body 240. The C-shaped hook 400a is disposed on the cover body 402, and the bolt 318 is disposed on the top surface of the back connecting plate 303. Furthermore, a protrusion 316 is disposed on the inner surface of the first side retaining plate 308. The protrusion 316 is used for supporting the first hook 416 while the cover 400 is on the flipping position. Another protrusion (not shown) could be disposed on the inner surface of the second side retaining plate 310, and used for supporting the second hook 422 while the cover 400 is on the flipping position. So that, the cover 400 is flipped in a maximum angle.

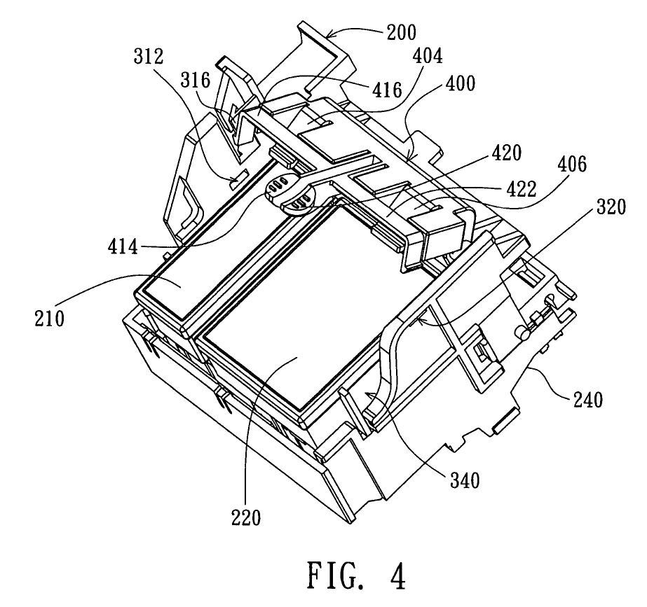

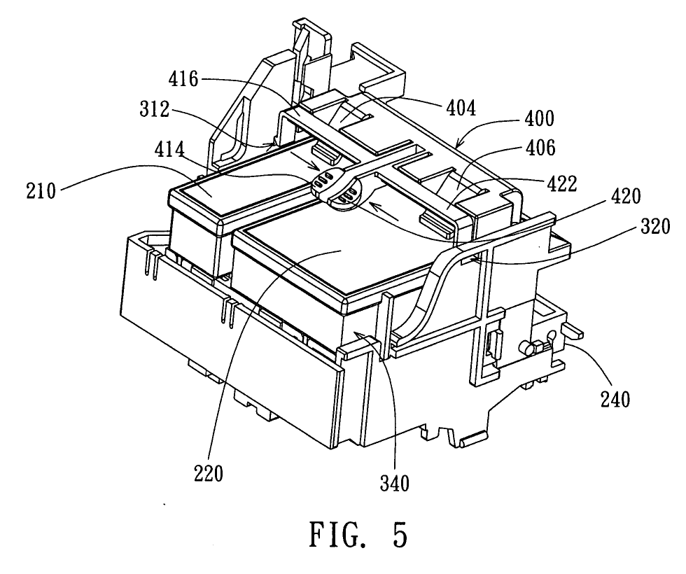

As shown in FIG. 4, when the N ink cartridges, such as ink cartridges 210 and 220, are disposed within the containing chamber 340, a user could force the cover 400, so that the cover 400 swings forward the top surfaces of the ink cartridges 210 and 220. When the first hook 416 and the second hook 422 respectively lock with the first positioning hole 312 and the second positioning hole 320, the cover 400 is on the fixing position, as shown in FIG. 5. At the same time, the first pendent portion 404 and the second pendent portion 406 press respectively the ink cartridges 210 and 220 downward to fasten the ink cartridges 220 and 210 within the containing chamber 340.

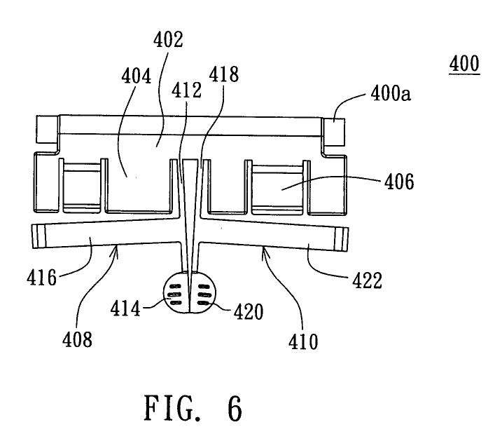

As shown in FIGS. 5 and 6, when the user want to take out the ink cartridges 210 and 220 form the containing chamber 340, the user forces the first forcing arm 414 and the second forcing arm 420 closely. Then, the first hook 416 and the second hook 422 could release from the first positioning hole 312 and the second positioning hole 320 respectively, and the cover 400 moves back to the flipping position, as shown in FIG. 4.

However, as one skilled in the art known, the foregoing preferred embodiment of the present invention is illustrated of the present invention rather than limiting of the present invention. For example, the ink cartridge carrier 200 could be disposed on a printer, or on a multi-function peripheral (MFP), either.

The foregoing preferred embodiment of the present invention disclosed an ink cartridge carrier with a pendent portion and a suspending arm, which are used for a cover flipping on a back retaining plate. The advantage of the present invention is that the operation space of the cover is saved, and makes the multi-function peripheral (MFP) smaller and lighter than prior art. In addition, the assembling components for the ink cartridge carrier decrease, and the cost for manufacturing materials also decreases.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An ink cartridge carrier, comprising:
a carrier body having a containing chamber, wherein the containing chamber is for receiving N ink cartridges, and the N is a positive integer; and
a cover connecting pivotally with the carrier body in a swinging way, and swinging forward and backward on the carrier body, the cover comprising;
a cover body; and
N pendent portions, wherein the N pendent portions and the cover body are formed in an integral structure, and the N pendent portions press the N ink cartridges, so that the N ink cartridges are fastened within the containing chamber.

2. The ink cartridge carrier according to claim 1, wherein the carrier body includes a first side retaining plate, the first side retaining plate has a first positioning hole, and the cover further comprises:
a first linking shaft having a first end and a second end, the first end connecting with the cover body, the second end elongated from the cover body to the top of the containing chamber;
a first forcing arm connecting with the second end; and
a first hook connecting perpendicular to the first linking shaft and between the first end and the second end, wherein the first hook, the first forcing arm and the first linking shaft are together to form a first “T” shaped structure,
when the first hook is lodged in the first positioning hole, the N pendent portions pressing the N ink cartridges tightly, and
when the first forcing arm is forced, the first hook releasing from the first positioning hole.

3. The ink cartridge carrier according to claim 2, wherein a protrusion is further disposed on an inner surface of the first side retaining plate, and the protrusion is for supporting the first hook, so that the cover is flipped in a maximum angle.

4. The ink cartridge carrier according to claim 2, wherein the carrier body includes a second side retaining plate opposite to the first side retaining plate, the second side retaining plate has a second positioning hole, and the cover further comprises:
a second linking shaft having a third end and a fourth end, the third end connecting with the cover body, the fourth end elongated from the cover body to the top of the containing chamber;
a second forcing arm connecting with the fourth end; and
a second hook connecting perpendicular to the second linking shaft and between the third end and the fourth end, wherein the second hook, the second forcing arm and the second linking shaft are together to form a second “T” shaped structure,
when the second hook is lodged in the second positioning hole, the N pendent portions pressing the N ink cartridges tightly, and
when the first forcing arm and the second forcing arm are forced to close to each other, the first hook and the second hook releasing from the first positioning hole and the second positioning hole respectively.

5. The ink cartridge carrier according to claim 4, wherein a first protrusion is further disposed on an inner surface of the first side retaining plate, and the first protrusion is for supporting the first hook, so that the cover is flipped in a maximum angle.

6. The ink cartridge carrier according to claim 5, wherein a second protrusion is further disposed on an inner surface of the second side retaining plate, and the second protrusion is for supporting the second hook, so that the cover is flipped in the maximum angle.

7. The ink cartridge carrier according to claim 4, wherein each of the N pendent portions is an elastic body.

8. The ink cartridge carrier according to claim 4, further comprising a pivot for connecting the cover and the carrier body.

9. The ink cartridge carrier according to claim 1, wherein each of the N pendent portions is an elastic body.

10. The ink cartridge carrier according to claim 1, further comprising a pivot for connecting the cover and the carrier body.

11. A printer, comprising:
an ink cartridge carrier, comprising:
a carrier body having a containing chamber, wherein the containing chamber is for receiving N ink cartridges, and the N is a positive integer; and
a cover connecting pivotally with the carrier body in a swinging way, and swinging forward and backward on the carrier body, the cover comprising;
a cover body; and
N pendent portions, wherein the N pendent portions and the cover body are formed in an integral structure, and the N pendent portions press the N ink cartridges, so that the N ink cartridges are fastened within the containing chamber.

12. The printer according to claim 11, wherein the carrier body includes a first side retaining plate, the first side retaining plate has a first positioning hole, and the cover further comprises:
a first linking shaft having a first end and a second end, the first end connecting with the cover body, the second end elongated from the cover body to the top of the containing chamber;
a first forcing arm connecting with the second end; and
a first hook connecting perpendicular to the first linking shaft and between the first end and the second end, wherein the first hook, the first forcing arm and the first linking shaft are together to form a first “T” shaped structure,
when the first hook is lodged in the first positioning hole, the N pendent portions pressing the N ink cartridges tightly, and
when the first forcing arm is forced, the first hook releasing from the first positioning hole.

13. The printer according to claim 12, wherein a protrusion is further disposed on an inner surface of the first side retaining plate, and the protrusion is for supporting the first hook, so that the cover is flipped in a maximum angle.

14. The printer according to claim 12, wherein the carrier body includes a second side retaining plate opposite to the first side retaining plate, the second side retaining plate has a second positioning hole, and the cover further comprises:
a second linking shaft having a third end and a fourth end, the third end connecting with the cover body, the fourth end elongated from the cover body to the top of the containing chamber;
a second forcing arm connecting with the fourth end; and
a second hook connecting perpendicular to the second linking shaft and between the third end and the fourth end, wherein the second hook, the second forcing arm and the second linking shaft are together to form a second “T” shaped structure,
when the second hook is lodged in the second positioning hole, the N pendent portions pressing the N ink cartridges tightly, and
when the first forcing arm and the second forcing arm are forced to close to each other, the first hook and the second hook releasing from the first positioning hole and the second positioning hole respectively.

15. The printer according to claim 14, wherein a first protrusion is further disposed on an inner surface of the first side retaining plate, and the first protrusion is for supporting the first hook, so that the cover is flipped in a maximum angle.

16. The printer according to claim 15, wherein a second protrusion is further disposed on an inner surface of the second side retaining plate, and the second protrusion is for supporting the second hook, so that the cover is flipped in the maximum angle.

17. The printer according to claim 14, wherein each of the N pendent portions is an elastic body.

18. The printer according to claim 14, wherein further comprising a pivot for connecting the cover and the carrier body.

19. The printer according to claim 11, wherein each of the N pendent portions is an elastic body.

20. The printer according to claim 11, wherein further comprising a pivot for connecting the cover and the carrier body.
